(19) United States
(12) Patent Application Publication
(10) Pub. No.: US 2020/0238733 A1
(43) Pub. Date: Jul. 30, 2020

(54) CLAMPING DEVICE FOR A PRINTABLE MEDIUM

(71) Applicant: Hewlett-Packard Development Company, L.P., Spring, TX (US)

(72) Inventors: Isidoro Maya Agudo, Sant Cugat del Valles (ES); Eduardo Martin, Sant Cugat del Valles (ES); Ignasi Bonjoch, Sant Cugat del Valles (ES)

(73) Assignee: Hewlett-Packard Development Company, L.P., Spring, TX (US)

(21) Appl. No.: 16/632,556

(22) PCT Filed: Oct. 19, 2017
(86) PCT No.: PCT/US2017/057302

§ 371 Date: Jan. 21, 2020

(51) Int. Cl. B41J 11/70; B41J 15/04

(52) U.S. Cl. CPC B41J 11/70; B41J 11/007; B41J 15/04

(57) ABSTRACT

A clamping device for a feed of a printable medium comprises a clamp to clamp the printable medium; and a force transfer mechanism to press the clamp against the printable medium; wherein the clamp comprises a magnet to increase a force onto the printable medium during clamping.

### BACKGROUND

In a printer, a printable medium is provided by a feeding device and may be moved to a printing zone which may comprise an assembly of nozzles ejecting a printing fluid onto the printable medium. The printable medium can be delayed in a portion of the printer between the printing zone and the feeding device, such as to allow for cutting of the printable medium.

### BRIEF DESCRIPTION OF THE DRAWINGS

The following detailed description will best be understood with reference to the drawings, wherein:

FIG. 1A illustrates a schematic of a clamping device according to an example.

FIG. 1B illustrates a schematic of a clamping device according to an example.

FIG. 2 illustrates a schematic of a printer including a clamping device according to an example.

FIG. 3 illustrates a side view of a buffer zone in a portion of a printer according to an example.

FIG. 4 illustrates a view of a portion of a printer with a plurality of clamping devices according to an example.

FIG. 5 shows a measurement of a displacement angle of several clamps arranged longitudinally on a shaft according to an example.

FIG. 6 illustrates an assembly of a clamping device with a spring according to an example.

FIGS. 7A-D illustrate top/bottom/side views of a clamp with a height adjustment mechanism, the height adjustment mechanisms being adjusted to different heights in FIGS. 7C and 7D, respectively, according to an example.

FIG. 8 depicts an exploded view of a clamping device according to an example.

FIG. 9 illustrates a schematic side view of a printer according to an example.

FIG. 10 illustrates a flow diagram of a method to create a buffer of a printable medium according to an example.

### DETAILED DESCRIPTION

To controllably delay a printable medium in a printer, a clamping device may be used. Examples herein relate to a clamping device, a printer and a method for creating a buffer of a printable medium P and may be combined in an arbitrary fashion.

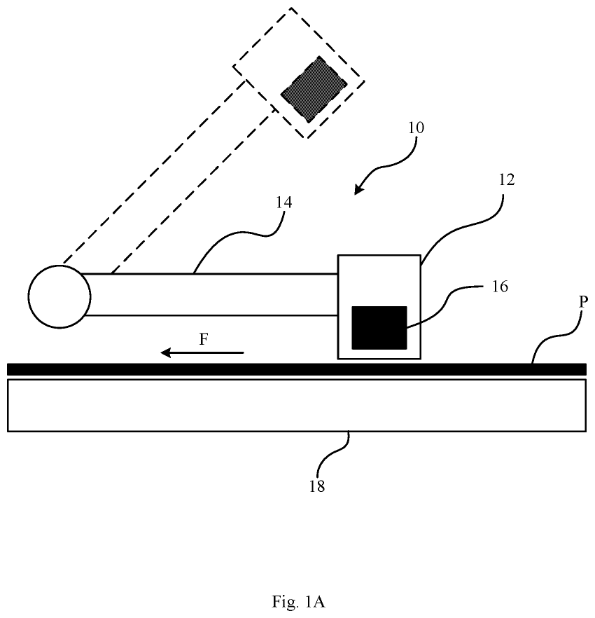

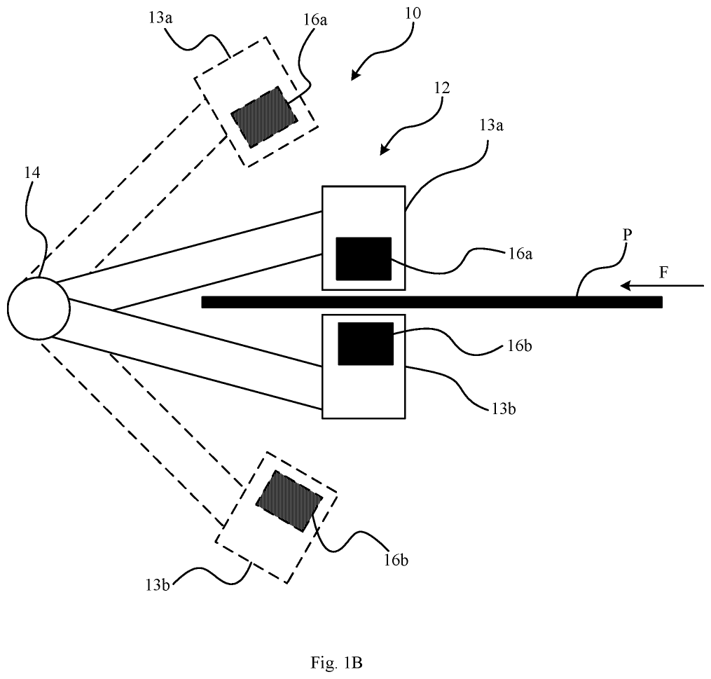

FIG. 1A shows a schematic view of a clamping device 10 for a feed of a printable medium P comprising a clamp 12 to clamp the printable medium P and a force transfer mechanism 14 to press the clamp 12 against the printable medium P. The clamp 12 comprises a magnet 16 to increase a force onto the printable medium P during clamping.

The printable medium P may be any medium on which a printing fluid can be applied. In the following, the functionality of printers, clamping devices or methods according to examples will be described with respect to the printable medium P made of paper; however, any printable medium P may be used. For example, the printable medium P may be paper and/or paper-based, such as cardboard, and/or textiles and/or leather and/or polymers and/or combinations thereof, etc.

In some examples, the printable medium P has a certain degree of elasticity/rigidity to form a buffer such as a bubble or buckle, when the feed of the printable medium P is clamped by the clamping device 10 and additional printable medium P is supplied towards the clamping device 10.

The printing fluid may be any appropriate material suitable to print a graphical or shaped element onto the printable medium P, such as a printing fluid or a build material. The graphical or shaped element may be a text, an image, lines, shapes, letters, numerals, signs, symbols or a combination of these in an arbitrary color, alignment or shape.

The printable medium P may be provided in the form of a sheet having a width. For example, the width of the printable medium P may be 5 to 100 inches, or 6 to 80 inches, or 8 to 60 inches, or 11 to 40 inches. The thickness of the printable medium P may be defined by its weight per area. For example, the printable medium P may have a weight per area of 20 to 150 g/m2, or 40 to 120 g/m2, or 60 to 100 g/m2.

The clamping device 10 may press the clamp 12 onto the printable medium P to controllably delay the feed of the printable medium P. The feed may have a feed direction F, which in FIG. 1 is illustrated by an arrow going from right to left, but is not limited to any direction and may have an arbitrary direction, such as going from left to right or any other direction.

The force along a normal direction, with respect to the feed direction F, of the clamping device 10 onto the printable medium P (also referred to as normal force component or as clamping force) that can be provided by the force transfer mechanism 14 may lead to a friction that may be high enough to delay or stop the printable medium P. The clamping device 10 may clamp the printable medium P between the clamp 12 and a feed support 18.

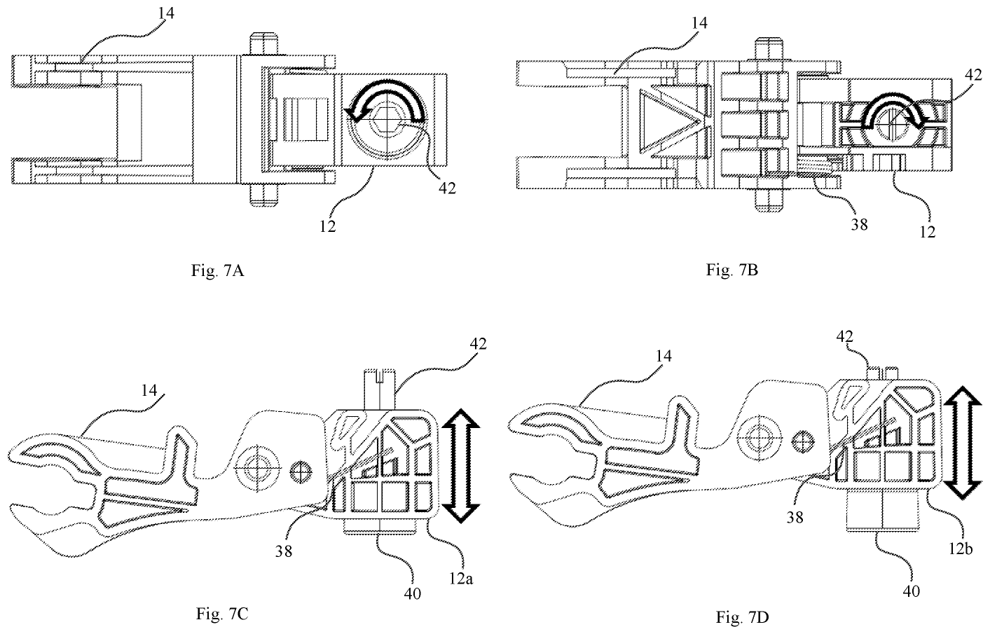

In some examples, the clamp 12 may comprise a clamping contact (not shown in FIG. 1A, but shown in FIGS. 7A-D and 8) facing the printable medium P to increase a friction between the clamp 12 and the printable medium P. The clamping contact may comprise a friction increasing material with respect to the printable medium P. For example, the clamping contact may comprise an elastomer, such as urethane, or may comprise rubber, silicone, ethylene propylene diene monomer (EPDM) rubber, Nitrile butadiene rubber (NBR), synthetic rubber, fluoropolymer elastomer, cork, or a combination thereof.

The magnet 16 comprised in the clamp 12 may increase a force of the clamping device 10 onto the printable medium P (e.g. the clamping force). To that end, it may interact with a magnetizable portion of the feed support 18. The magnetizable portion may be a magnetic material, such as alloys comprising Fe, Ni, Co, or combinations thereof, but may not be limited to these and, for example, may also comprise alloys comprising Mn, such that a magnetic attraction occurs between the clamp 12 and the feed support 18.

The magnet 16 may also comprise a magnetic material or combinations of magnetic materials. For example, the magnet may comprise a neodymium magnet made from the elements Ne, Fe and B (such as Ne₂Fe₁₄B) or a samarium cobalt magnet made from the elements Sm and Co (such as SmCo₅), but in general any magnet with a suitable magnetic remanence may be used.

A magnetic attraction between the magnetizable portion of the feed support 18 and the magnet 16 may lead to an increase of the clamping force, which may be referred to as a magnetic force component. The magnetizable portion may also be permanently magnetized and may constitute a second magnet.

In other words, the clamping device 12 may comprise a feed support 18 to support the printable medium P, the feed support 18 comprising a magnetizable material and/or a second magnet to increase the force of the clamp 12 onto the printable medium P.

In an example shown in FIG. 1B, the clamping device 10 comprises a clamp 12 comprising two parts 13a,13b, such as an upper part 13a and a lower part 13b, arranged to clamp the printable medium P between said two parts 13a,13b, when the force transfer mechanism 14 presses the clamp 12 against the printable medium P. The magnet 16 may be arranged in the upper part 13a of the clamp 12 and/or the lower part 13b of the clamp 12. For example, magnets 16a,16b may be arranged in the upper part 13a and the lower part 13b of the clamp 12, respectively.

In some examples, the magnets 16a,16b may be arranged opposite each other such that an upper magnet 16a in the upper part 13a interacts with a lower magnet 16b in the lower part 13b and thereby increases the clamping force.

The parts 13a,13b may comprise a magnetizable portion to interact with the magnet 16a,16b and to increase the clamping force onto the printable medium P. For example, an upper magnet 16a may be arranged in the upper part 13a of the clamp 12 and the lower part 13b may comprise a magnetizable portion. Hence, a magnetic attraction between the magnet 16a and the magnetizable portion may increase the clamping force of the clamp 12 onto the printable medium P by a magnetic force component (or magnetic clamping force component).

Referring to FIGS. 1A and 1B, the force transfer mechanism 14 may further comprise a motor to press the clamp 12 against the printable medium P, such as a rotary motor (not shown) connected to a shaft of the force transfer mechanism 14.

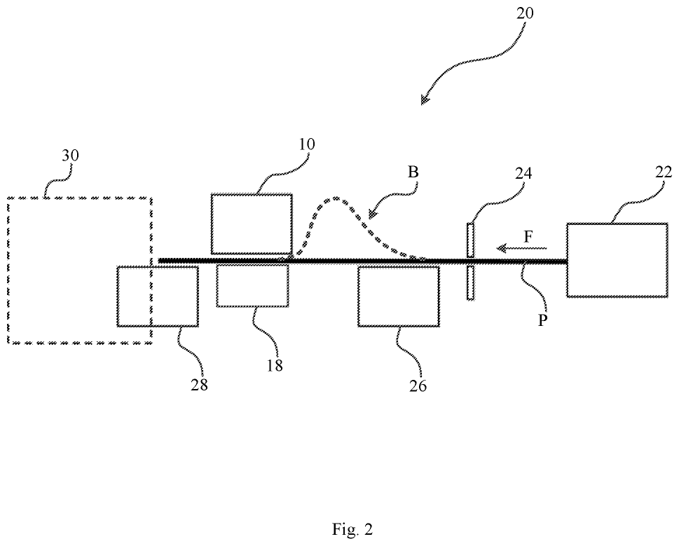

The clamping device 10 may be used in a printer 20, such as to create a buffer of the printable medium for cutting. As shown in the example of FIG. 2, the printer 20 comprises a feed mechanism 22 to provide a feed of printable medium P in a feed direction F. The feed direction (along vector F) that the printable medium P is transported to will in the following be defined as a downstream direction, whereas the direction that the printable medium P originates from will be defined as an upstream direction.

A cutter 24 may be used to adjust the length of the printable medium P. The printable medium P may be fed to a support 26, past a retarder mechanism, such as the clamping device 10, and towards a conveyor belt 28 which drags the printable medium P into a printing zone 30 for printing.

In FIG. 2, the cutter 24 is shown as being located downstream of the feed mechanism 22. However, the cutter 24 may also be comprised in the feed mechanism 22 or may be located upstream of the feed mechanism 22 and adjust the length of the printable medium P from a reservoir (not shown) upstream of the feed mechanism 22. For example, the feed mechanism 22 may be an assembly of rolls, which turn to pick up the printable medium P from a reservoir and to accelerate the feed of the printable medium P in the downstream direction, and the cutter 24 may be positioned before the assembly of rolls, or within the assembly of rolls, or after the assembly of rolls.

The acceleration and/or feed velocity of the feed mechanism 22 may be chosen, such that a buffer B may be formed in a buffer zone upstream of the printing zone 30. For example, the feed mechanism 22 may accelerate the printable medium P to a feed velocity which is larger than the drag velocity of the conveyor belt 28. The buffer B may be formed upstream of the conveyor belt 28 and downstream of the feed mechanism 22. The location, wherein the buffer B may be formed, may depend on a friction onto the printable medium P downstream of the location and/or may depend on a preconfigured bent in the feed of the printable medium P. For example, the printable medium P may leave the feed mechanism 22 at a higher feed velocity into a zone wherein the printable medium P may not be constrained vertically and may therefore form wrinkles/bubbles illustrated as the buffer B, when the velocity of the conveyor belt 28 is smaller than the feed velocity.

The conveyor belt 28 may be a drag device, which drags the printable medium P into the printing zone 30. The conveyor belt 28 may comprise an assembly of rolls. In some examples, a belt material may be arranged on the assembly of rolls such that the belt material may be dragged along a closed path around and/or defined by the assembly of rolls. The belt material may comprise a friction increasing material with respect to the printable medium P such as an elastomer, for example urethane, or may comprise rubber, silicone, EPDM, Nitrile butadiene rubber (NBR), synthetic rubber, fluoropolymer elastomer, cork, or a combination thereof. Thereby a friction between the conveyor belt 28 and the printable medium P can be used to drag the printable medium P into the printing zone 30. Additionally, the conveyor belt 28 may comprise holes to be connected to a vacuum source to (dynamically and/or statically) increase a suction force onto the printable medium P and thereby increase a dragging force as a function of the connection to the vacuum source. Moreover, additional rolls may be used to press the printable medium P onto the conveyor belt 28 to increase and/or balance a dragging force of the conveyor belt 28.

The drag device or conveyor belt 28 may convey the printable medium P at a specific drag velocity towards the printing zone 30. For example, the conveyor belt 28 may convey the printable medium P at an average drag velocity of 0.1 to 20 IPS (inches per second), or 1 to 18 IPS, or 2 to 16 IPS, such as 15 IPS.

While the printer 20 is printing on the printable medium P in the printing zone 30, the cutter 24 may cut the printable medium P to a certain length. In some examples, the feed of the printable medium P is halted in the cutter 24 during cutting of the printable medium P. The printer 20 may continue printing on the printable medium P by consuming the buffer B during cutting. The buffer B may be refilled by the feed mechanism 22 in between cutting, when the feed velocity of the printable medium P in the feed mechanism 22 is higher than the drag velocity of the conveyor belt 28.

When the length of the printable medium P is reduced, the frequency of the cutting in the cutter 24 may need to increase to achieve a constant high printing speed. However, the acceleration of the printable medium P by the feed mechanism 22 after stopping the feed of the printable medium P for cutting may be limited. Hence, the buffer B may be consumed by the conveyor belt 28 at a faster rate than the supply rate for the printable medium P by the combination of the feed mechanism 22 and the cutter 24. When the buffer B is consumed, a dragging force by the conveyor belt 28 may be transferred through the printable medium P to the cutter 24. Therefore, the printable medium P may be strained downstream of the cutter 24, which may lead to skew and/or shear affecting the cutting or which may lead to a deterioration of the printable medium P and/or damage to components of the printer 20.

The rate at which the buffer B is consumed may be changed by reducing the speed of the conveyor belt 28. However, the inertia of the conveyor belt 28 may limit an acceleration of the conveyor belt 28, when the length of the printable medium P is again increased, which may reduce the overall printing speed and/or may lead to an increase of the energy consumption of the printer 20 through the deceleration and/or acceleration of the conveyor belt 28.

The clamping device 10 may be used to delay the printable medium P, for example when the consumption rate for the printable medium P by the conveyor belt 28 is larger than the supply rate for the printable medium P by the feed mechanism 22. The printable medium P may be halted in the buffer zone by the clamping device 10 and hence, the printable medium P may slip along the conveyor belt 28 without advancing towards the printing zone 30 or may advance more slowly towards the printing zone 30. The printing in the printing zone 30 may be controllably halted or delayed until the clamping device 10 releases the printable medium P without slowing down the conveyor belt 28.

To hold or delay the printable medium P, the clamping force of the clamping device 10 (e.g. the normal component of the force of the clamping device 10 onto the printable medium P) may be higher than a dragging force of the conveyor belt 28 onto the printable medium P. The magnet 16 of the clamping device 10 may interact with a feed support 18 and/or another part of the clamp 12 and thereby increase the clamping force by the magnetic force component.

In some examples, the clamping force of the clamping device 10 may be adjusted along a transverse direction, which may be transverse to the feed direction F of the printer 20. In some examples, the transverse direction may also comprise a transverse component transverse to the feed direction F and a parallel component parallel to the feed direction F and may form an angle different from 90 degrees with the feed direction F. In other words, the clamping force of the clamping device 10 may be adjusted along a transverse component of an adjustment direction, which may be transverse to the feed direction F of the printer 20.

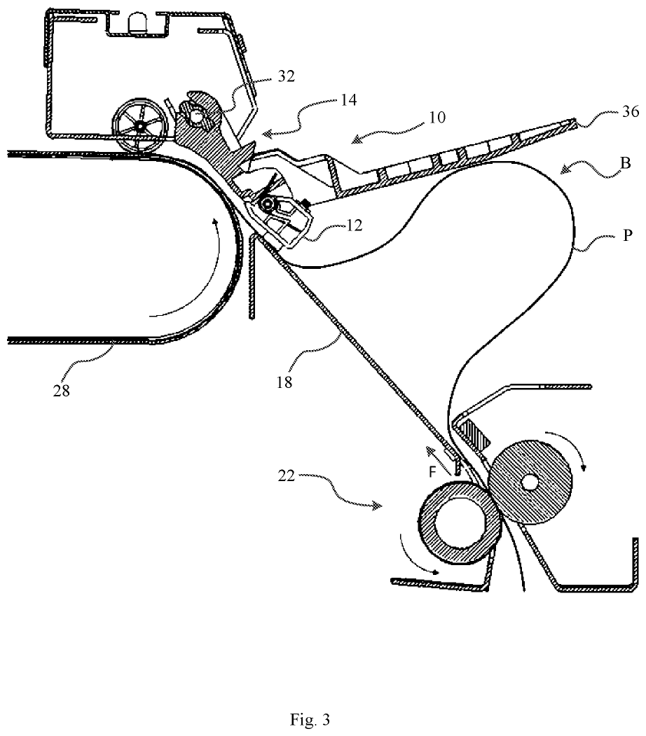

In an example shown in FIG. 3, a schematic side view of a printer 20 in the area around the buffer zone B is shown. The paper P may be fed from the feeding device 22 and may form a buffer B in front of the clamping device 10. A medium holding device 36 may control the form of the buffer B of the printable medium P. The clamping device 10 clamps the printable medium P between the clamp 12 and the feed support 18 such that the printable medium P slips with reduced speed along the conveyor belt 28. The clamp 12 can be pressed against the printable medium P by the force transfer mechanism 14 which is attached to a shaft 32. For example, by turning the shaft 32, the force transfer mechanism 14 may follow the rotational movement of the shaft 32 and may pinch/clamp the printable medium P between the feed support 18 and the clamp 12.

According to some examples, the clamping device 10 comprises a plurality of clamps 12 which may be arranged in a transverse direction to a feed direction F of the printable medium P and may cooperate to clamp the printable medium P.

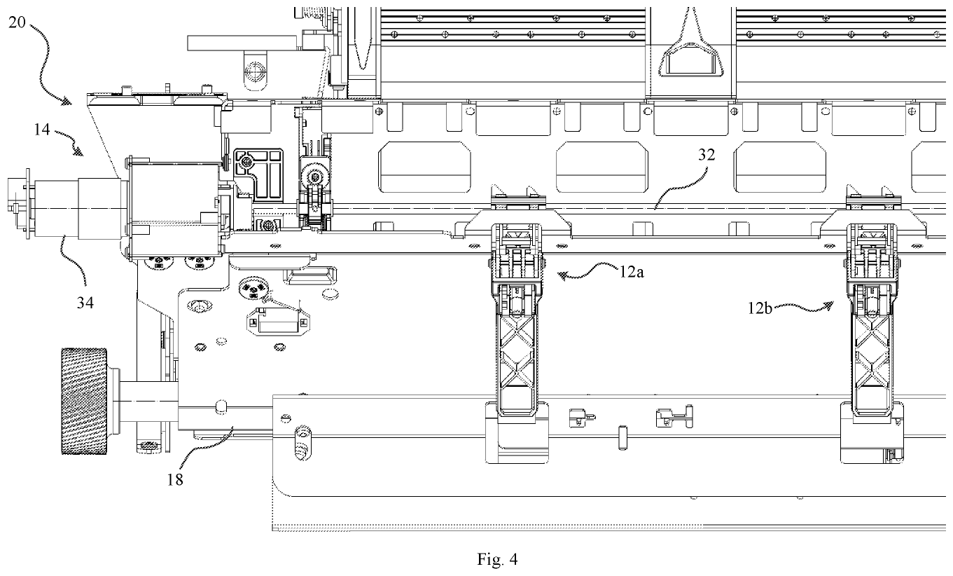

In some examples, the plurality of clamps 12 is arranged on a shaft 32 connected to a motor (not shown in FIG. 3, but shown in FIG. 4), wherein the motor turns the shaft 32 and presses the plurality of clamps 12 against the printable medium P to achieve a synchronized clamping action of the clamps 12 across the width of the printable medium P.

As shown in the schematic side view of FIG. 4, multiple clamps 12a, 12b can be used to clamp the printable medium P along the transverse direction. A first clamp 12a and a second clamp 12b may be attached to the shaft 32 and may be pressed against the feed support 18 when the shaft 32 is turned. The printer 20 may comprise a motor 34 that can generate a torque onto the shaft 32 which may lead to a turning motion of the shaft 32. As shown in FIG. 4, the force transfer mechanism 14 may comprise the shaft 32 and arms attached to the shaft 32, wherein the arms may be connected to clamps 12a, 12b of a plurality of clamps and may press the clamps against the printable medium P.

In other words, the clamping device 10 or retarder mechanism may comprise a motor 34 and a shaft 32 oriented transverse to a feed direction F of the feed and connected to the motor 34, wherein a plurality of clamps are connected to the shaft 32, and wherein clamps 12a,12b of the plurality of clamps generate a force onto the printable medium P when the shaft 32 is turned by the motor 34 and the clamps 12a, 12b may each comprise magnets 16 to adjust a force onto the printable medium P transverse to the feed direction F.

The clamps 12a, 12b may clamp the printable medium P at synchronized points in time. When the clamps 12a, 12b touch the printable medium P at the same time, the printable medium P may be clamped without generating wrinkles and/or skew in the printable medium P.

When the motor 34 turns the shaft 32 the generated torque may generate a torsion of the shaft 32. The torsion of the shaft 32 may lead to differences in the synchronization of the clamping action of the first clamp 12a and the second clamp 12b and/or may lead to differences in the clamping force between the first clamp 12a and the second clamp 12b.

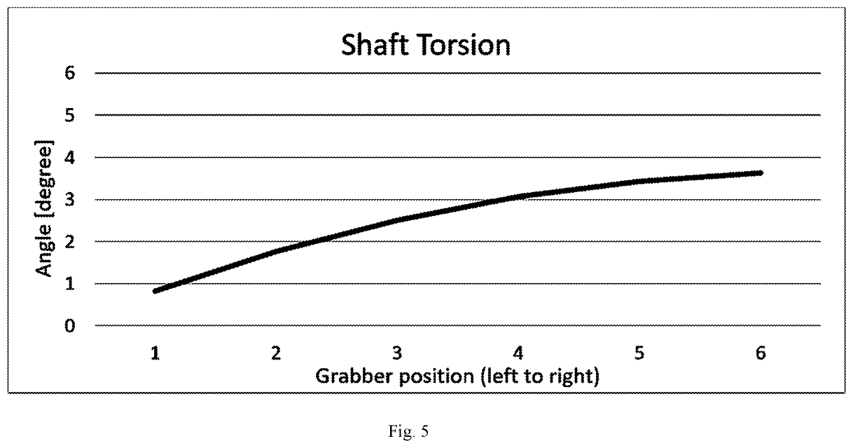

FIG. 5 shows a measured graph of a displacement angle of clamps or grabbers arranged in the transverse direction along a shaft 32 against the position of the clamps for a printer 20 with six clamps according to an example. The displacement angle may be an angular position of a clamp with respect to a rotation axis of the shaft 32 or may be a relative angular difference between an angular position of a portion of the shaft 32 (reference) and an angular position of a clamp during and/or after a rotation of the shaft 32, when compared to an initial configuration. The clamps attached to the shaft may have a different rotational position during and/or after rotation of the shaft 32 resulting from a displacement of the angular position of the clamps, which may be different between clamps. The displacement angle may depend on a longitudinal position of the clamp along the shaft 32. As shown in FIG. 5, a first clamp may be misaligned with respect to a sixth clamp by almost 3 degrees due to a torsion of the shaft 32. Hence, a clamping force and/or a synchronization between the clamps may be skewed.

If the clamping action of the clamps is not synchronized, for example when the first clamp 12a touches the printable medium P before the second clamp 12b, the clamping force may become asymmetric along the transverse direction and may lead to a skew of the printable medium P. The skew may produce wrinkles in the printable medium P and/or may cause rips in the printable medium P. For example, the first clamp 12a may touch the printable medium P a few milliseconds before the second clamp 12b due to a different rotational position of the clamps 12a,12b, such as the different rotational position generated by the torsion of the shaft 32. The asynchronous clamping may be addressed with the techniques described below.

In some examples, the force transfer mechanism 14 may be coupled to the clamps 12,12a,12b with a spring 38. The spring 38 may be biased when the clamping device 10 clamps the printable medium P. A bias of the spring 38 may be a deformation, such as a compression and/or a stretching and/or a twisting, of the spring, for example of a structure and/or an arrangement and/or a shape and/or a material of the spring 38, wherein the bias may create a force with a force component directed against the direction of deformation.

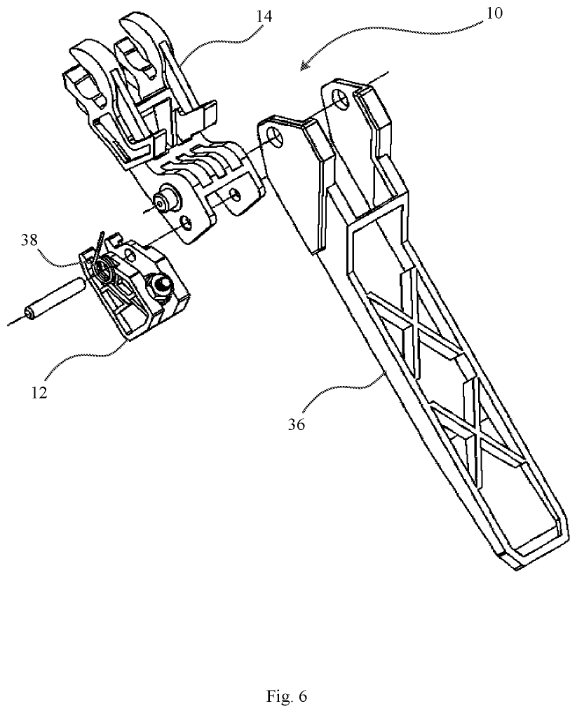

In FIG. 6, a disassembled clamping device 10 is shown. The clamping device 10 comprises the clamp 12 and the force transfer mechanism 14 and is coupled to the medium holding device 36. The clamp 12 may be rotably attached to the force transfer mechanism 14 and can be coupled to the force transfer mechanism 14 by means of the spring 38. In other words, the force transfer mechanism 14 may comprise the spring 38 coupled to the clamp 12. For example, when the torsion of the shaft 32 leads to a different angular position of the clamps, the spring 38 can be biased to accommodate differences of the angular position of the clamps.

In some examples, the spring 38 may be used to adjust a normal force of the clamps 12a,12b of the plurality of clamps onto the printable medium P. In some examples, the plurality of clamps comprise a first clamp 12a coupled to a first spring of the force transfer mechanism 14 and a second clamp 12b coupled to a second spring of the force transfer mechanism 14, wherein a bias and/or preload of the first spring is different from a bias and/or preload of the second spring to adjust the force of the clamps onto the printable medium P along the transverse direction.

In some examples, a moveable portion of the clamp 12,12a,12b is coupled to a body of the clamp 12,12a,12b with a spring 38 to be biased when the clamping device 10 clamps the printable medium P.

In some examples, the angular position of the clamps 12a,12b may be adjusted with the force transfer mechanism 14 to synchronize different clamps 12a,12b.

Additionally, the position of a component of the clamp 12 may be adjusted to adjust a synchronization of different clamps 12a,12b. FIGS. 7A and 7B show a clamp 12 attached to a force transfer mechanism 14 comprising a height adjustment mechanism 42 according to a top view and a bottom view, respectively. The height adjustment mechanism 42 allows to adjust a position of a portion of the clamp 12, which is to be brought in contact with the printable medium P.

FIGS. 7C and 7D show a first clamp 12a and a second clamp 12b each attached to a force transfer mechanism 14 and/or coupled to the force transfer mechanism 14 with a spring 38. The height adjustment mechanisms 42 of the first clamp 12a and the second clamp 12b are adjusted to a different position in FIGS. 7C and 7D, respectively, as indicated by the arrows.

The clamps 12,12a,12b may further comprise a clamping contact 40 arranged to face the printable medium P and to increase a friction between the clamp 12 and the printable medium P. The clamping contact 40 may be arranged on and/or on top of a height adjustment mechanism 42.

In FIGS. 7A-D, the height adjustment mechanism 42 is shown as a screw. However, any mechanism to adjust the position of the component touching the printable medium P may be used. The height adjustment mechanism 42 may be a moveable part of the clamp 12,12a,12b to adjust a distance between the clamp 12 and the printable medium P. For example, the height adjustment mechanism 42 may be a spacer and/or a moveable part, such as a rod, attached to the clamp with a clamping or interlocking mechanism, wherein the moveable part may be moveable unless firmly clamped or locked. The height adjustment mechanism 42 may further comprise an actuator, such as a motor, to adjust a configuration of a height of the height adjustment mechanism 42. The height adjustment mechanism 42 may further comprise a control unit and associated circuitry.

In some examples, the magnet 16 may be attached to the height adjustment mechanism 42 which may adjust a distance between the clamp 12 and the printable medium P. When the distance between the clamp 12 and the printable medium P is adjusted to the torsion, the clamping action of the clamps 12,12a,12b of a plurality of clamps may be synchronized. In some examples, the distance between the clamp 12 and the printable medium P, when the printable medium P is not clamped, may be adjusted to adjust or balance or equilibrate the force between clamps 12a,12b of a plurality of clamps.

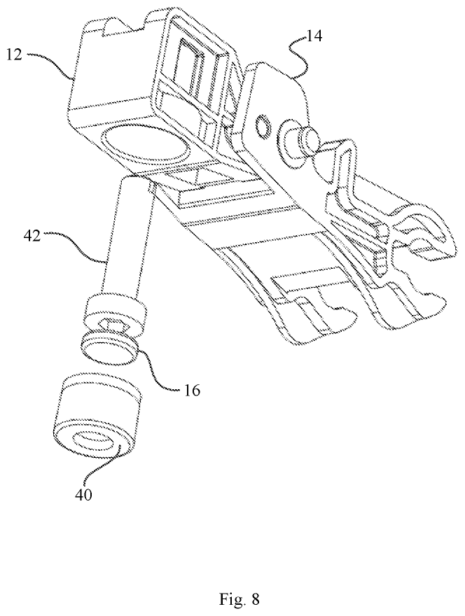

FIG. 8 shows an exploded view of an example of a clamp 12 connected to a force transfer mechanism 14 and comprising a height adjustment mechanism 40 and a magnet 16, the magnet 16 being arranged between the height adjustment mechanism 40 and the clamping contact 42.

In some examples, a distance between the clamp 12 and/or the magnet 16 and/or the printable medium P can be modified by arranging a spacer between the magnet 16 and the height adjustment mechanism 40 and/or the clamping contact 42. In some examples, a spacer can be the height adjustment mechanism 40.

If the clamping force of the first clamp 12a and the second clamp 12b is different, then a clamping force above a clamping threshold may not be reached for both the first clamp 12a and the second clamp 12b. For example, in FIG. 5 a clamping force of the first clamp against the printable medium P may be 6 N and a clamping force of the sixth clamp onto the printable medium P may be 2.5 N, when the clamps are in contact with the printable medium P. The different rotational position of the clamps may be offset by biasing springs connecting the clamps to the force transfer mechanism 14 or by adjusting the different rotational positions of the clamps with a force transfer mechanism 14 and/or a height adjustment mechanism 42 as discussed above for other examples. The clamping threshold may be the force that is needed to stop the printable medium P against a dragging force of the conveyor belt 28, such as 4 N. When the torsion of the shaft 32 reduces a torque of the shaft 32 at the position of the second clamp 12b, then a clamping threshold may be reached for the first clamp 12a, but may not be reached for the second clamp 12b. If the clamping threshold is not reached, then the printable medium P may slip under the respective clamp 12a,12b and not be stopped. Therefore, the printable medium P may be skewed and/or become wrinkled even when the clamps 12a,12b touch the printable medium P at the same time.

The magnet 16 can be used to increase the clamping force of the first clamp 12a and/or the second clamp 12b by the magnetic force component. By increasing the clamping force, the magnet 16 may increase the clamping force and may adjust or balance or equilibrate a clamping force of a plurality of clamps 12a,12b along the transverse direction.

In some examples, a first magnet of the first clamp 12a and a second magnet of the second clamp 12b may have the same magnetization and/or remanence. The first magnet may increase the clamping force of the first clamp 12a by a value that can be equal to the increase of the clamping force by the second magnet of the second clamp 12b onto the printable medium P, such as 2 N. Then the sum of the clamping force due to the magnet 16 and the clamping force induced by the force transfer mechanism 14 may be above a clamping threshold for the first clamp 12a and the second clamp 12b.

In some examples, the sum of the clamping force due to the magnet 16 and the clamping force induced by the force transfer mechanism 14 may be above a clamping threshold for all the clamps of the clamping device 10.

In some examples, the clamping threshold may be adjusted by a modification of the dragging force during clamping, such as changing a suction force of the conveyor belt 28 onto the printable medium P.

In some examples, the magnetic force component can be different for the first clamp 12a and the second clamp 12b. In other words, the first clamp 12a of the plurality of clamps may comprise a first magnet 16 and a second clamp 12b of the plurality of clamps may comprise a second magnet 16, wherein a magnetic clamping force component of the second magnet 16 may be adjusted to be different from a magnetic clamping force component of the first magnet 16.

For example, the magnetization and/or remanence and/or material of the magnets 16 may be different between clamps 12a,12b to adjust a force between the clamp 12a,12b and the printable medium P.

The magnetic force component may also depend on a distance between the magnet and a magnetizable portion and/or a second magnet at an opposite side of the printable medium P. By adjusting the distance, the magnetic force component can be adjusted.

In some examples, a first clamp 12a of the plurality of clamps comprises a clamping contact 40 with a first thickness and a second clamp 12b of the plurality of clamps comprises a clamping contact 40 with a second thickness, wherein the first thickness and the second thickness are different to adjust the force of the magnet onto the printable medium P. When the clamping contact 40 is arranged on and/or on top of the magnet 16, the thickness of the clamping contact 40 modifies the distance between the magnet 16 and the printable medium P (or the feed support 18). Therefore, the first magnet can induce a different magnetic force component onto the printable medium P compared to a magnetic force component of the second magnet, when the thickness of the clamping contact 40 is different between clamps 12a,12b.

In some examples, such as the one shown in FIG. 4, the clamping contacts 40 can be arranged on and/or on top of the magnets 16 and face the printable medium P, and a thickness of the clamping contacts 40 may vary between two or more clamps 12a,12b as a function of a distance to the motor 34.

The modified magnetic force component may offset or adjust or compensate a difference of the clamping force between different clamps 12a,12b attached to a shaft 32 due to the torsion of the shaft 32.

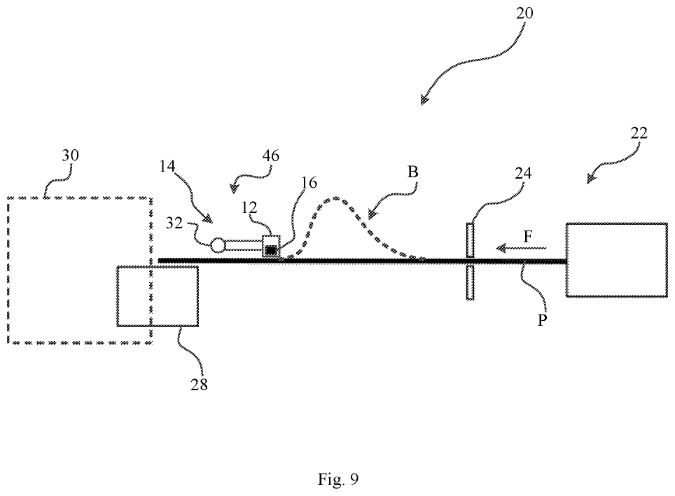

In the example of FIG. 9, a schematic view of a printer 20 is shown. The printer 20 comprises a printing zone 30, which may comprise a conveyor belt 28 to transport a printable medium P, a buffer zone B upstream of the printing zone 30, and a feed mechanism 22 to provide a feed of the printable medium P to the buffer zone B and the printing zone 30. The feed mechanism 22 may comprise a cutter 24 to adjust a length of the printable medium P. The buffer zone B may comprise a retarder mechanism, such as a clamping device 10, to temporarily delay the feed to the printing zone 30 and thereby create a buffer B of the printable medium P in the buffer zone B. The retarder mechanism 10 may comprise a motor and a shaft 32 oriented transverse to a feed direction F (or oriented with a component of orientation being transverse to the feed direction F) of the feed and connected to the motor, wherein a plurality 46 of clamps 12 may be connected to the shaft 32. Clamps 12 of the plurality 46 of clamps may generate a force onto the printable medium P when the shaft 32 is turned by the motor and may comprise magnets 16 to adjust a force onto the printable medium P transverse to the feed direction F.

In FIG. 9 a clamp 12 of the plurality 46 of clamps above the printable medium P is shown. To clamp the printable medium P, the clamp 12 may interact with a feed support and/or a lower part of the clamp 12 (not shown in FIG. 9, but shown in FIGS. 1A to 4).

In some examples, the retarder mechanism 10 may be a clamping device 10 and/or may comprise some of the features of the examples of clamping devices 10 described above.

Using the clamping device 10 or retarder mechanism 10, the printer 20 may be arranged or adjusted to at least partially compensate a reduction of the clamping force onto the printable medium P due to a torsion of the shaft 32 using the magnets 16.

The clamps 12 may comprise clamping contacts 40 to increase a friction between the clamps 12 and the printable medium P.

Additionally, in the printer 20 the clamping contacts 40 may be arranged on and/or on top of the magnets 16 and face the printable medium P, wherein a thickness of the clamping contacts 40 may vary between two or more clamps 12 as a function of a distance to the motor. By modifying the thickness of the clamping contact 40, the magnetic force component may be modified and may partially compensate the reduction in clamping force due to a torsion of the shaft 32 that may be a function of the distance to the motor along the shaft 32.

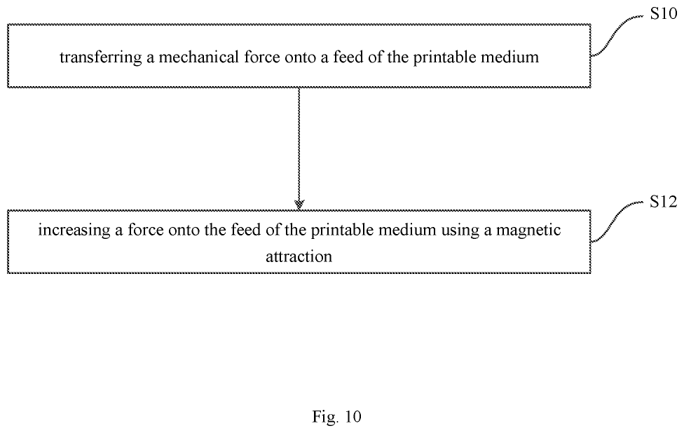

FIG. 10 shows a flow diagram of a method for creating a buffer of a printable medium comprising transferring S10 a mechanical force onto a feed of the printable medium; and increasing S12 a force onto the feed of the printable medium using a magnetic attraction.

The method may be implemented in a printer as described above and/or may use a clamping device to create the buffer. The force onto the feed of the printable medium may be increased by a magnet arranged in a clamp interacting with a magnetizable material, which may be part of a printer or clamping device.

In some examples, the method may further comprise adjusting a thickness of a contact material contacting the printable medium, such as while creating the buffer, to adjust the magnetic attraction. The contact material may be arranged on and/or on top of a magnet of a clamping device used to implement the method.

The method may further comprise adjusting a bias of a spring to adjust a force onto the feed of the printable medium. The spring may be comprised in a clamping device to clamp the printable medium and may couple a clamp and a force transfer mechanism or the clamp and a moveable portion of the clamp facing the printable medium.

Furthermore, the method may comprise implementing and/or providing a clamping device as described above and/or may implement functions of the above-mentioned examples or of features of the above-mentioned examples of clamping devices.

1. A clamping device for a feed of a printable medium comprising:
a clamp to clamp the printable medium; and
a force transfer mechanism to press the clamp against the printable medium;
wherein the clamp comprises a magnet to increase a force onto the printable medium during clamping.

2. The clamping device of claim 1, wherein the clamping device comprises a plurality of clamps which are arranged in a transverse direction to a feed direction of the printable medium and cooperate to clamp the printable medium.

3. The clamping device of claim 2, wherein a first clamp of the plurality of clamps comprises a first magnet and a second clamp of the plurality of clamps comprises a second magnet, wherein a magnetic clamping force component of the second magnet is adjusted to be different from a magnetic clamping force component of the first magnet.

4. The clamping device of claim 1, wherein the force transfer mechanism further comprises a spring coupled to the clamp.

5. The clamping device of claim 2, wherein the plurality of clamps comprise a first clamp coupled to a first spring of the force transfer mechanism and a second clamp coupled to a second spring of the force transfer mechanism, wherein a bias of the first spring is different from a bias of the second spring.

6. The clamping device of claim 1, wherein the force transfer mechanism further comprises a motor to press the clamp against the printable medium.

7. The clamping device of claim 2, wherein the plurality of clamps is arranged on a shaft connected to a motor, wherein the motor turns the shaft and presses the plurality of clamps against the printable medium.

8. The clamping device of claim 1, wherein the magnet is attached to a height adjustment mechanism to adjust a distance between the clamp and the printable medium.

9. The clamping device of claim 2, wherein a first clamp of the plurality of clamps comprises a clamping contact with a first thickness and a second clamp of the plurality of clamps comprises a clamping contact with a second thickness; and
wherein the first thickness and the second thickness are different.

10. A printer comprising:
a printing zone comprising a conveyor belt to transport a printable medium;
a buffer zone upstream of the printing zone; and
a feed mechanism to provide a feed of the printable medium to the buffer zone and the printing zone;
wherein the feed mechanism comprises a cutter to adjust a length of the printable medium;
wherein the buffer zone comprises a retarder mechanism to temporarily delay the feed to the printing zone and thereby create a buffer of the printable medium in the buffer zone;
wherein the retarder mechanism comprises a motor and a shaft oriented transverse to a feed direction of the feed and connected to the motor, wherein a plurality of clamps are connected to the shaft; and
wherein clamps of the plurality of clamps generate a force onto the printable medium when the shaft is turned by the motor and comprise magnets to adjust a force onto the printable medium transverse to the feed direction.

11. The printer of claim 10, wherein the magnets are configured to at least partially compensate a reduction of the force onto the printable medium due to a torsion of the shaft.

12. The printer of claim 11, wherein the clamps comprise clamping contacts to increase a friction between the clamps and the printable medium and wherein the clamping contacts are arranged on the magnets and face the printable medium, and wherein a thickness of the clamping contacts varies between two or more clamps as a function of a distance to the motor.

13. A method for creating a buffer of a printable medium comprising:
transferring a mechanical force onto a feed of the printable medium; and
increasing a force onto the feed of the printable medium using a magnetic attraction.

14. The method of claim 13, further comprising adjusting a thickness of a contact material contacting the printable medium to adjust the magnetic attraction.

15. The method of claim 14, further comprising adjusting a bias of a spring to adjust a force onto the feed of the printable medium.
